(19) United States
(12) Patent Application Publication
(10) Pub. No.: US 2010/0020788 A1
(43) Pub. Date: Jan. 28, 2010

(54) Method for Establishing Multimedia Connections Across the Borders of Packet-Switching Communications Networks

(75) Inventors: Patrick Kleiner, Munchen (DE); Joachim Lüken, Munchen (DE); Mohammad Vizaei, Wien (AT); Walter Zinki, Wien (AT)

Correspondence Address: LERNER GREENBERG STEMER LLP, P O BOX 2480, HOLLYWOOD, FL, 33022-2480, US

(73) Assignee: Nokia Siemens Networks GmbH & Co KG, Muenchen (DE)

(21) Appl. No.: 11/885,263

(22) PCT Filed: Feb. 27, 2006
(86) PCT No.: PCT/EP2006/060286

§ 371 Date: Sep. 22, 2009

(30) Foreign Application Priority Data
Feb. 28, 2005 (AT) A357/2005

(51) Int. Cl. H04L 12/66

(52) U.S. Cl. 370/352

(57) ABSTRACT

The invention relates to a method for establishing multimedia connections across the borders of packet-switching communications networks according to an Internet protocol and the ITU-Standard H.323, consisting in inserting (connect) a rearwardly pointing authorisation cycle into a standard connection set-up, thereby making it possible to overcome in a simple manner the FIREWALLS restrictions for multimedia connections, in particular voice connections, over IP.

The invention relates to a method for establishing multimedia connections across the borders of packet-switching networks according to the internet protocol and ITU Standard H.323.

In recent years, communication networks have developed to become a significant communication medium, by means of which a number of services are offered. The best known computer network worldwide is the Internet, which is the designation of all the networks connected to each other and using the Internet protocol IP as a transport protocol.

The Internet protocol IP is responsible at level 3 of the OSI layer model for the connectionless transport of data from a sender, sometimes via several networks, to a receiver, with neither error detection nor error correction taking place.

Transport protocols such as the Transmission Control Protocol TCP or the User Datagram Protocol UDP are established on the Internet Protocol and on these in turn an almost unmanageable variety of different application protocols, that are sometimes competing, such as http, FTP or the SIP Protocol for the management of multimedia connections.

For multimedia connections on the Internet there are at present two competing standards for signaling, i.e. H.323 and SIP. The ITU (International Telecommunication Union) standard H.323 was developed for realtime transmission of multimedia applications such as voice and video communication in packet-oriented networks. As an umbrella standard it houses a number of protocols, for example for signaling, for the exchange of terminal functionalities and status information and also for controlling connections and data flow. The most important protocols of the H.323 standard include H.225, H.245 and H.450.x. H.225 describes signaling protocols such as RAS (Registration, Admission, Status) and call signaling. H.245 functions as a control protocol for multimedia communication. The H.450 standard additionally defines telephony functions in order, for example, to depict the performance features of ISDN on IP.

The Session Initiation Protocol SIP was developed by the IETF (Internet Engineering Task Force). The standard defines a signaling protocol for setting up, modifying and ending sessions with two or more users. The Session Initiation Protocol SIP also serves for the transmission of realtime data over packet-supported networks and is functionally comparable with the protocols in accordance with the ITU standard H.323. The Session Initiation Protocol SIP can switch interactive communication services including voice over IP networks; the transport functions by TCP (Transmission Control Protocol) or UDP (User Datagram Protocol). Furthermore, the Session Initiation Protocol SIP is responsible for call signaling and for the localization and registration of users. In particular it also enables the switching of the identity of the caller and also call forwarding in IP networks. The Session Initiation Protocol SIP is text-oriented, is based on HTTP (Hypertext Transfer Protocol) and therefore offers an open Internet-based structure. New performance features can be implemented relatively easily and quickly on this basis.

A further essential standard for multimedia connections is the Media Gateway Controller Protocol MGCP, which supports telephony between the Internet and the conventional telephone network, and provides a connection control protocol (not a signaling protocol) for this purpose. Both the H.323 standard and also the Session Initiation Protocol SIP can be used as protocols for the transmission of MGCP control instructions.

The invention relates to networks according to the H.323 standard and is therefore based on the task of further improving multimedia connections across network borders.

Firewalls according to the NAT (Network Address Translation) process are used at these network borders, especially between private networks and public networks. NAT is a method which describes the conversion of IP addresses from one network to a different network and is used on routers or firewalls. This is used mainly to protect subnetworks against virus attacks and increase the available address space of the Internet. However, this hinders data traffic using multimedia connections.

According to the invention, this problem is solved by means of a method for automatic address conversion at the borders of communication networks according to the Internet protocol ITU standard H.323, with a rearwardly pointing authorization cycle being inserted into a standard connection setup.

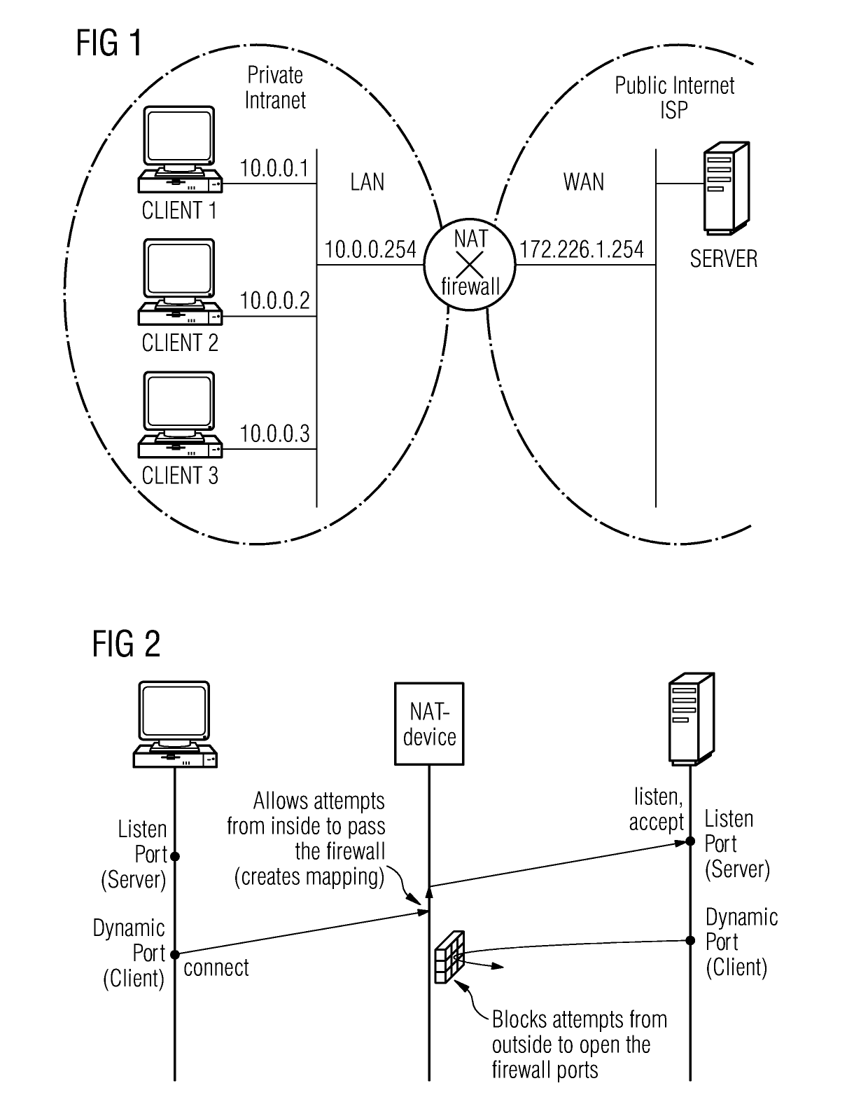

The invention is explained in more detail using an exemplary embodiment shown in FIG. 1 to 6.

The illustrations are as follows:

FIG. 1 A schematic showing the use of a NAT router for address transformation,

FIG. 2 A schematic of a typical message flow between a server and client,

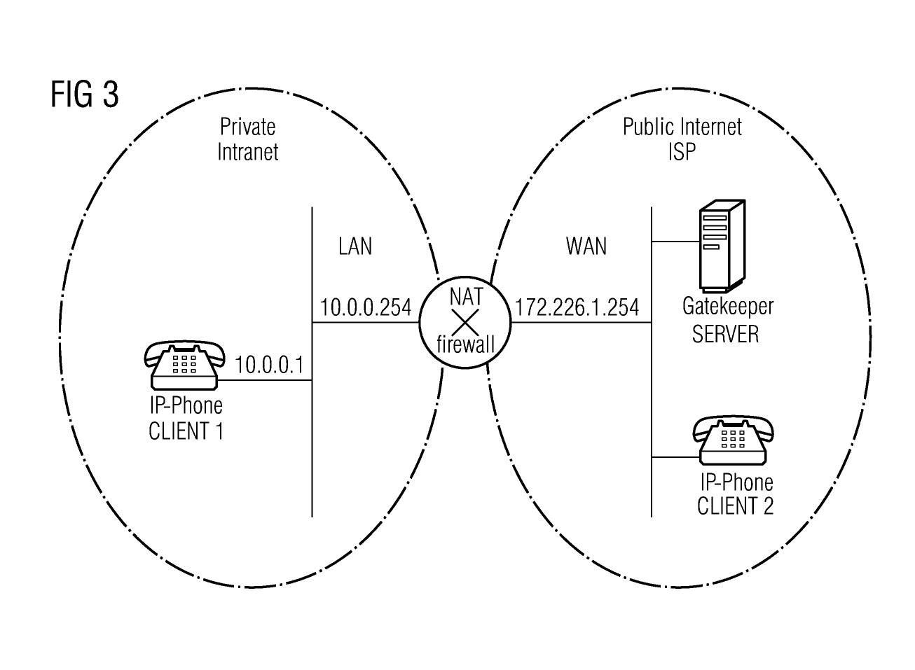

FIG. 3 A typical connection between two different networks,

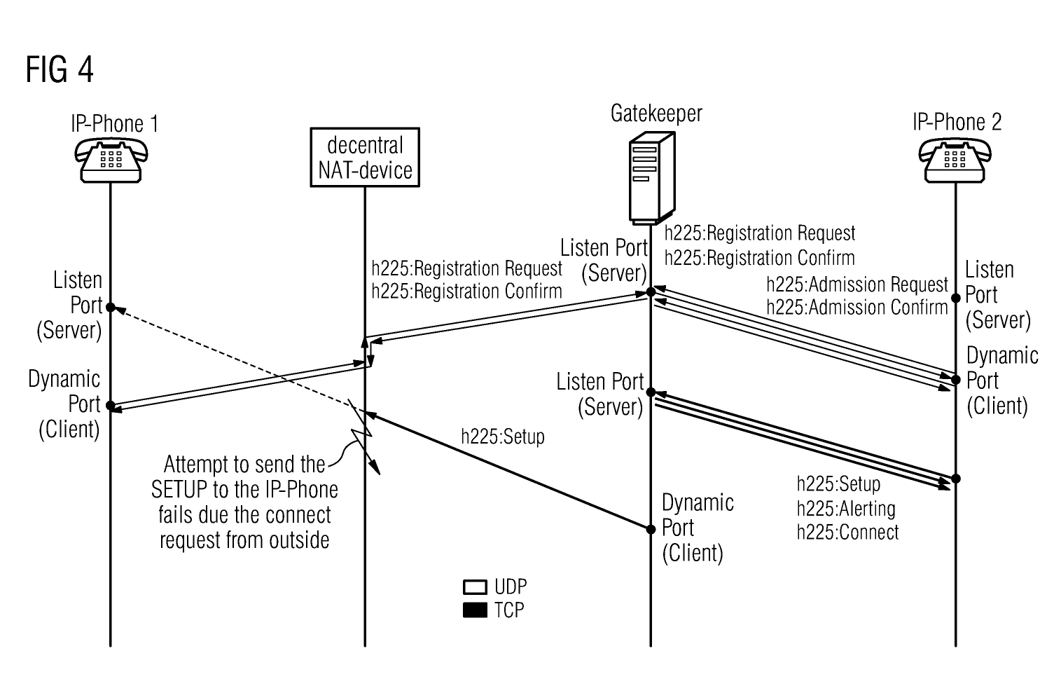

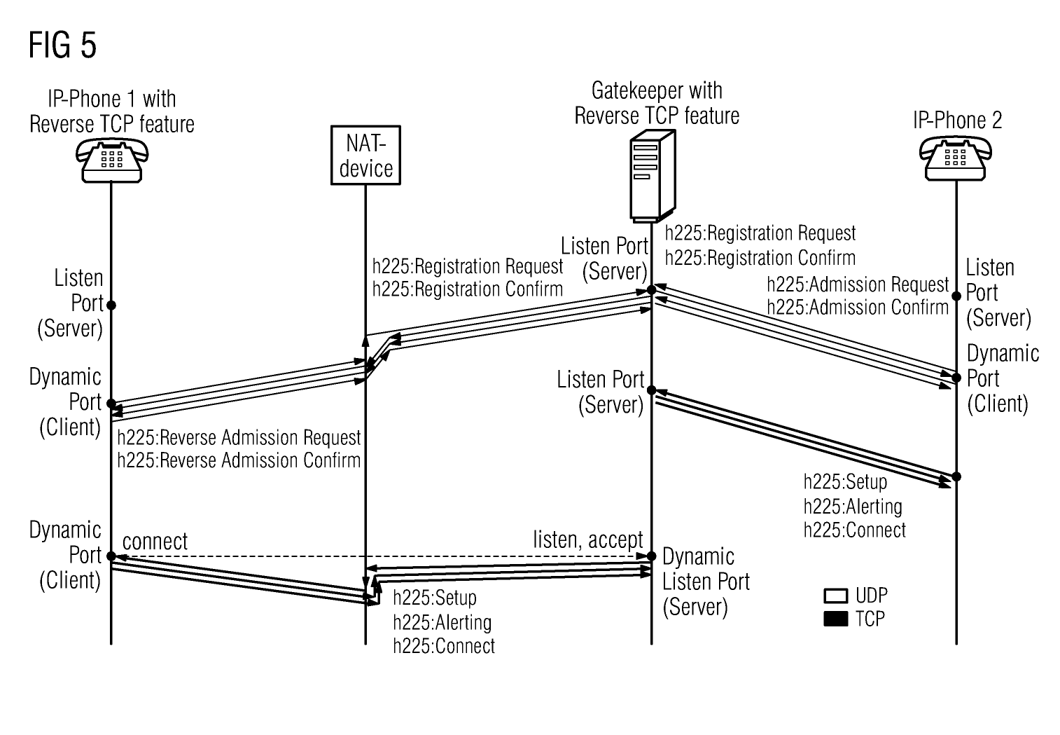

FIG. 4 A typical sequence of a connection setup via a NAT router,

FIG. 5 An example of a connection setup according to the invention,

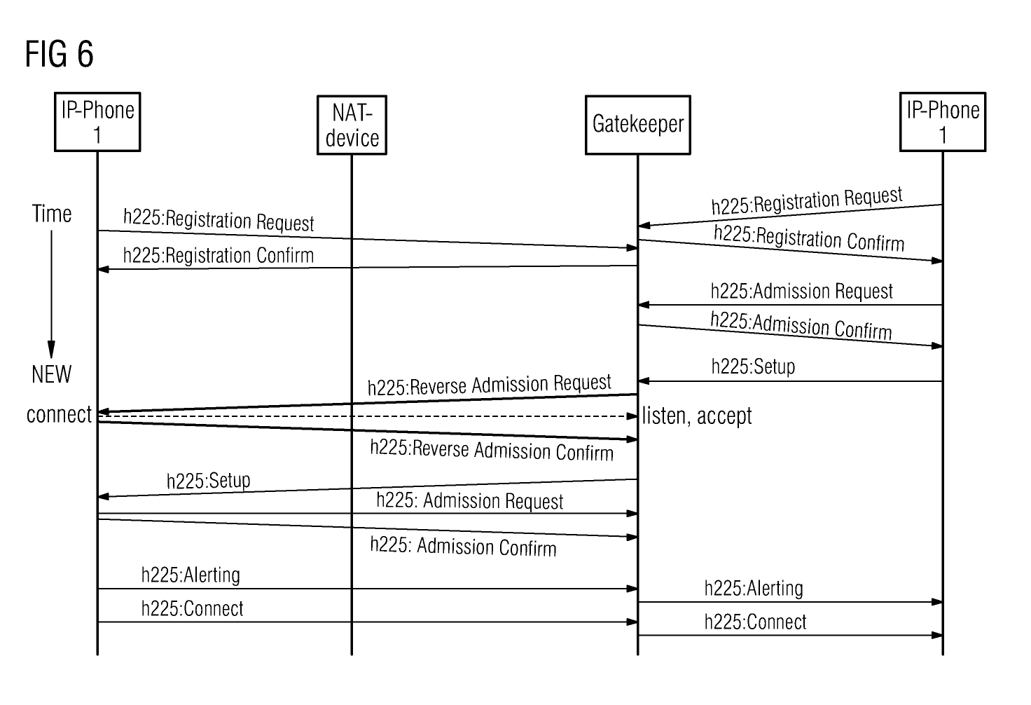

FIG. 6 A further example of a connection setup according to the invention, taking account of the time relationship.

The schematic shown in FIG. 1 for using a NAT router includes a private network PN, for example the intranet of a company, and a public network ISP.

Both networks are connected to each other by means of a NAT router.

NAT (Network Address Translation) is a method which describes the conversion of IP address from one network to a different network and is used on routers or firewalls. With NAT, a network address 10.0.0.2 can be converted to 192.168.0.2, a further IP 10.0.0.3 to 192.168.0.3 etc. A special form of NAT is present if the IP addresses of all machines in a network (e.g. 10.0.0.2 to 10.0.0.253) are converted to a single IP address. This enables the IP addresses of single or several networks to be hidden (masquerading) and a private network is thereby presented externally by a single IP address, e.g. 172.226.1.254.

As shown in FIG. 2, it is possible by use of the NAT router to establish a connection setup between a user of the private network and a user of the public network, provided this setup is activated by the user of the private network. In this case, a corresponding entry for the duration of the connection is stored in a “NAT table”. Attempts to setup a connection from the public network are, on the other hand, blocked. Particularly with Internet telephony, it is the case, as shown in FIGS. 3 and 4, that on the basis of the existing H.323 standard incoming calls from a public network user (external user) to a user of a private network (internal user, “behind a firewall”) can be signaled but no voice connection takes place because of NAT. In other words, the telephone of the internal user rings but no voice connection takes place even when the user lifts the receiver.

According to the invention, this problem is circumvented in that when there is a call from an external user to an internal user the actual connection setup is activated by the internal user. To do this, the internal user, after he has become aware from the signaling that an external user wishes to call him, activates the establishment of the voice connection by means of a “REVERSE ADMISSION CYCLE” by using the REVERSE ADMISSION REQUEST, REQUEST ADMISSION CONFIRM instructions. It is, of course, possible without difficulty to establish a connection from “inside” to “outside”, i.e. from a user within a private network to a user of the public network.

After this REVERSE ADMISSION CYCLE, the conventional connection setup is continued in accordance with the existing H.323 standard.

This setup is further explained on the basis of FIGS. 5 and 6, with the functional relationships being shown in FIG. 5 and the time relationships being shown in FIG. 6.

The connection setup according to the invention in this case takes place from an external user IP phone 2 via a server gatekeeper, a firewall NAT device to a called internal user IP-phone 1.

The sequence is as follows:

From the external user, a connection setup is started according to the H.225 standard with, according to the invention, a REVERSE ADMISSION CYCLE being inserted between the called internal user IP-PHONE 1 and the gatekeeper. In this process, the inventive REVERSE ADMISSION REQUEST contains information in its source address regarding a dynamic IP address and the TCP port by means of which the connection is to be routed by the server gatekeeper. After the internal user IP-PHONE 1 has received this request, a connection to the specified address of the server gatekeeper is established and the setup signal is awaited. The normal connection setup then continues according to the H.323 standard.

1. Method for establishing multimedia connections across the borders of packet-switching communication networks according to the Internet protocol and the ITU standard H.323, characterized in that a rearwardly pointing authorization cycle is inserted into the standard connection setup.
